(19) United States
(12) Patent Application Publication
(10) Pub. No.: US 2008/0018088 A1
(43) Pub. Date: Jan. 24, 2008

(54) Seat belt assembly

(75) Inventor: Mark F. Gray, Sterling Heights, MI (US)

Correspondence Address: FOLEY AND LARDNER LLP;SUITE 500, 3000 K STREET NW, WASHINGTON, DC, 20007, US

(73) Assignee: TAKATA SEAT BELTS, INC.

(21) Appl. No.: 11/490,148

(22) Filed: Jul. 21, 2006

(51) Int. Cl. B60R 22/00

(52) U.S. Cl. 280/808; 297/481

(57) ABSTRACT

The disclosed presenter arm assembly can be used for presenting a seat belt to a vehicle occupant. The assembly can include a presenting arm with a pivoting base having an interior cavity and a shaft portion extending from the pivoting base and a seat belt guide attached to an end of the shaft portion for guiding a seat belt. The assembly can include a resilient member for biasing the presenting arm to extend at a predetermined angle and/or a viscous damper to ease the rotation of the presenting arm.

### BACKGROUND

The present invention relates generally to the field of seat belt assemblies that are configured to provide easy access to a seat belt to a vehicle occupant, such as a front seat occupant in a coup.

Front seat belts in coupe type vehicles may be difficult for occupants to reach due to the rearward position of a guide loop in which the seat belt, or webbing, slides through. Belt presenters have been used to provide improved access seat belts to the occupants in the front seats. Belt presenters are generally to be pivotable to allow access to the rear seat. The use of detents in the pivot mechanism allows a back seat occupant to rotate the belt presenter. As a result, however, the presenter must be manually returned to the normal position to allow the front seat occupant to reach the belt and to avoid inducing excessive slack in the belt system. Various systems have been proposed to help alleviate this problem.

U.S. Pat. No. 4,033,594 to Lindblad discloses a belt guiding system that comprises a fixing plate, a guiding part that extends from the fixing plate, and a loop part attached to the fixing plate. A seat belt is fed through the loop part and the guiding part. The guiding system includes a series of gears on the fixing plate that allows the loop part to rotate in the same direction as the guiding part but to a lesser extent. The components are spring loaded such that, when not in use, the guiding part is kept in the forward direction so that the belt is easy to grip when an occupant wants to wear the belt. When a passenger wants to enter into the back seat of the vehicle, the guiding part can be rotated backward so that the passenger can enter unobstructed.

U.S. Pat. No. 4,890,951 to Morinaga et al. discloses a seat belt supporting device that comprises a bolt, a base plate with an extended arm, a loop for guiding the seat belt, a spring plate, and a cooperation holding arrangement. The base plate pivots around the bolt while the loop is provided on the end of the arm of the plate. The spring plate fits loosely and rotatably on the bolt and has a portion to be connected to a vehicle body in order to prevent the spring plate from turning about the longitudinal axis of the bolt. The spring plate has a predetermined degree of resiliency in the direction of the longitudinal axis of the bolt. The cooperating holding arrangement is provided in the form of three apertures on the base plate and two protrusions on the spring plate. The protrusions fit inside one set of the apertures in its home position and a different set of apertures when the base plate is rotated at a 90 degree angle from the home position when in use. Thus, the base plate can be held in its use or home position.

U.S. Pat. No. 4,645,232 to Hamada et al. discloses a seat belt system comprising a pivotal anchor plate having one end mounted on a bolt and another end provided with a buckle, a cam plate clamped between the anchor plate and the vehicle body, and a leaf spring. The leaf spring has one end secured to the anchor plate and the other end selectively engaging with engagement projections formed on the cam plate. The anchor plate can then be pivoted between an operative position and a housed position.

There is a need for a simple design in which the presenting arm can automatically return to the presenting position after being rotated to allow entry to the rear seat.

There is also a need to reduce the risk of added slack in the belt system as a result of the rotation of the presenting arm when allowing entry to the rear seat.

### SUMMARY

According to one embodiment of the present invention, a presenter arm assembly for presenting a seat belt to a vehicle occupant is disclosed. The presenter arm assembly may comprise a presenting arm with a pivoting base having an interior cavity and a shaft portion extending from the pivoting base; a seat belt guide attached to an end of the shaft portion for guiding a seat belt; an attachment bracket with a fixed portion that is adapted to engage a structure of a vehicle; and a resilient member. The resilient member may engage the presenting arm and the attachment plate such that the presenting arm is biased to extend at a predetermined angle relative to the fixed portion of the attachment bracket.

The attachment bracket may comprise an engaging arm that extends into the interior cavity of the pivoting base of the presenting arm. The resilient member may engage the engaging arm of the attachment plate. The pivoting base may comprise an engaging protrusion that extends into the interior cavity. The resilient member may engage that engaging protrusion of the pivoting base. The resilient member may comprise a spring.

According to another embodiment of the present invention, a presenter arm assembly for presenting a seat belt to a vehicle occupant may comprise: a presenting arm with a pivoting base having an interior cavity and a shaft portion extending from the pivoting base, wherein an interior wall protrudes into the interior cavity of the pivoting base; a seat belt guide attached to an end of the shaft portion for guiding a seat belt; a base insert disposed inside the interior cavity; and a viscous damper provided between the base insert and the interior wall.

According to another embodiment of the present invention, a seat belt assembly for restraining an occupant in a vehicle may comprise: a presenter arm assembly, a buckle; and a seat belt having a tongue attached for insertion into the buckle. The presenter arm assembly may comprise a presenting arm with a pivoting base having an interior cavity and a shaft portion extending from the pivoting base; a seat belt guide attached to an end of the shaft portion for guiding a seat belt; an attachment bracket with a fixed portion that is adapted to engage an interior structure of a vehicle; and a resilient member that engages the presenting arm and the attachment plate such that the presenting arm is biased to extend at a predetermined angle from the fixed portion of the attachment bracket.

It is to be understood that both the foregoing general description and the following detailed descriptions are exemplary and explanatory only, and are not restrictive of the invention as claimed.

### BRIEF DESCRIPTION OF THE DRAWINGS

These and other features, aspects and advantages of the present invention will become apparent from the following description, appended claims, and the accompanying exemplary embodiments shown in the drawings, which are briefly described below.

FIG. 1 shows an exploded view of a seat belt presenter arm assembly according to an embodiment of present invention.

FIG. 2 shows a cross-sectional view of the presenter arm assembly through the pivoting base of the presenting arm.

FIGS. 3(a)-3(e) show a seat belt guide attached to the presenter arm assembly according to an embodiment of the present invention. FIG. 3(a) shows a front view. FIG. 3(b) shows a side view. FIG. 3(c) shows an exploded view. FIG. 3(d) and 3(e) shows cross sectional views taken along section line A-A of FIG. 3(a) before and after the operation to secure the seat belt guide to the presenting arm.

FIG. 4 shows a side view of the presenter arm assembly attached to a vehicle pillar in a rotated position according to one embodiment of the present invention.

FIG. 5 shows a side view of the presenter arm assembly at the pivoting base of the presenting arm in the presenting position.

FIG. 6 shows a perspective view of the presenter arm assembly in the presenting position according to one embodiment of the present invention.

FIGS. 7(a) and 7(b) show side views of the presenter arm assembly at the pivoting base of the presenting arm in a first and second rotated positions respectfully.

FIG. 8 show a perspective view of the presenter arm assembly in a rotated position according to one embodiment of the present invention.

FIG. 9 shows a perspective view of the presenter arm assembly installed for use with a front seat of a vehicle.

### DETAILED DESCRIPTION

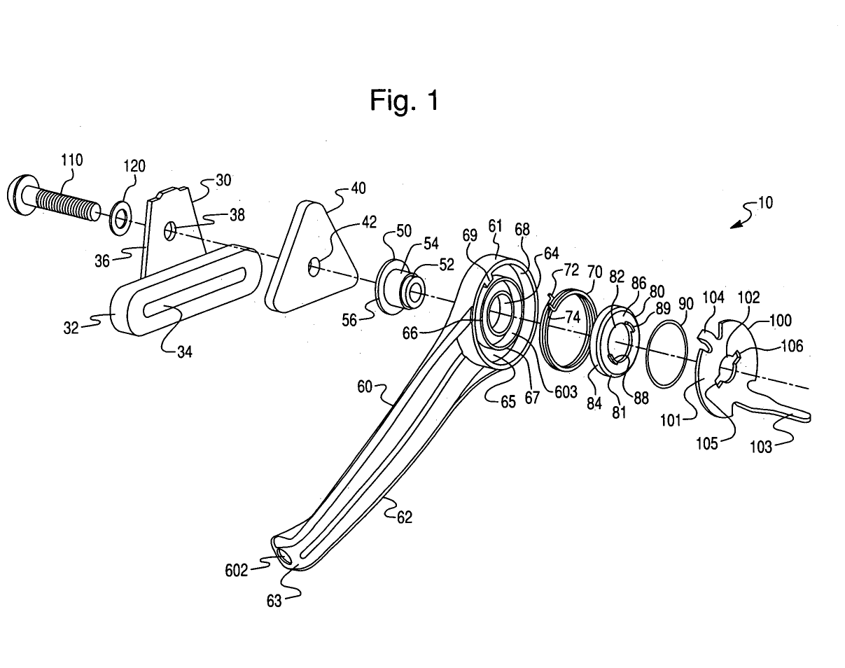

FIG. 1 is an exploded view of an embodiment of the presenter arm assembly 10, which may comprise a bolt 110, a lock washer 112, a D-ring guide 30, a D-ring guide plate 40, a bushing 50, a presenting arm 60, a resilient member 70, a base insert 80, a sealing member 90, and an attachment bracket 100. The entire assembly is held together using the bolt 110 and the lock washer 112 in which the bolt 110 screws into a threaded fitting on a vehicle structure such as, for example, a vehicle pillar so that the assembly is attached to the interior cabin of a vehicle.

The D-ring guide 30 may comprises a lower loop portion 32 and an upper attachment portion 36. The lower loop portion 32 includes an oval aperture 34 in which the seat belt (not shown) can be fed through. The upper attachment portion 36 includes an aperture 38 in which the bolt 110 is inserted during assembly. The D-ring guide can be any suitable material, such as plastic or metal.

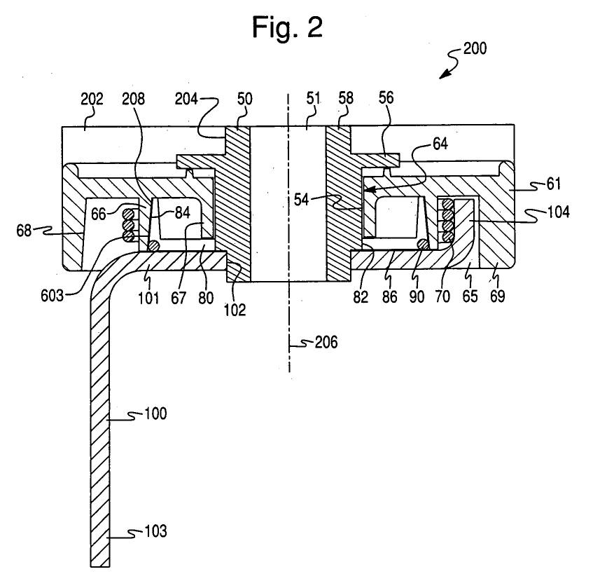

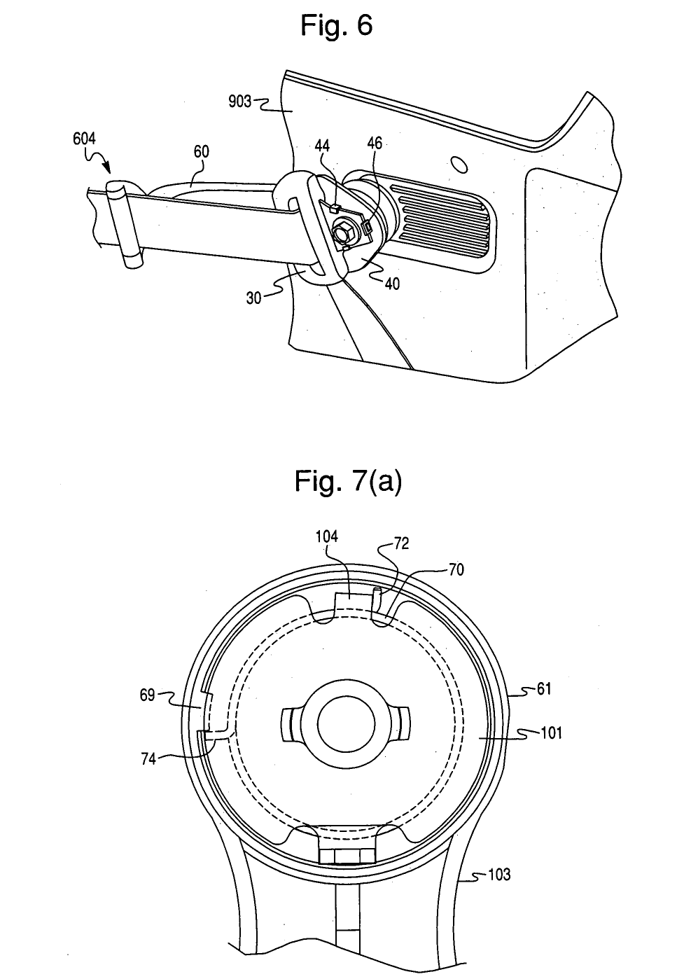

The D-ring guide 30 abuts against the D-ring guide plate 40, which also includes an aperture 42 that corresponds the aperture 38 of the D-ring guide 30 so that the bolt 110 can be fed through. The D-ring guide 30 and the D-ring guide plate 40 are configured to attach to each other so that they move as a single unit. This can be accomplished in several ways. As seen in FIG. 6, the D-ring guide plate 40 may comprise small protrusions 44 that clip to the edges of the D-ring guide 30. Alternatively or in addition, the D-ring guide plate 40 may have attachment loops 46 that encircle protrusions 39 that extend from the D-ring guide 30. In another embodiment, the D-ring guide plate 40 can include an aperture that has the same shape with the outer dimensions of the upper attachment portion 36 in which the D-ring guide 30 fits inside the aperture. In this fashion, the D-ring guide 30 and the D-ring guide plate 40 can rotate as one unit once the bolt 110 is fed through the presenter arm assembly and attached to the vehicle structure. Alternatively, the D-ring guide 30 and the D-ring guide plate 40 can be a single D-ring piece 202 as shown in FIG. 2.

Although not shown in either FIGS. 1 or 6, a cover may be placed over the D-ring guide 30, the D-ring guide plate 40, and the attachment bolt 110 once the entire assembly is attached to the vehicle. The D-ring guide cover can be attached to the D-ring guide plate 40 through the use of snap fittings or other known attachment devices.

The bushing 50 in FIG. 1 can be metal and acts as a pivot for the presenting arm 60. For example, the bushing 50 can be a bearing. In addition, as will be described later, the bushing also acts as a spacer that prevents the presenter arm assembly from being crushed when the bolt 110 is used to attach the assembly 10 to the vehicle. The bushing shown in FIGS. 1 and 2 can be generally cylindrical in shape and has a series of different diameters 52, 54, 56, and 58 along is longitudinal surface. The diameter 52 is dimensioned such that it will fit in an aperture 102 of the attachment bracket 100. The diameter 54 is dimensioned such that it will fit in the aperture 82 of the base insert 80 and aperture 64 of the presenting arm 60. The diameter 56 is a flange that abuts against the presenting arm 60 and the D-ring guide plate 40 (or the D-ring piece 202). The diameter 58 (shown in FIG. 2) is dimensioned such that it will fit in a corresponding aperture 42 in the D-ring guide plate 40 (or the D-ring piece 202). The bolt 110 used to assembly the presenter arm assembly 10 to fix the assembly 10 to the vehicle is fed through the aperture 51 of the bushing 50.

The presenting arm 60 is a component that can be made from plastic and may comprise a pivoting base 61, a shaft portion 62 extending from the pivoting base 61, and a distal portion 63 at the end of the shaft portion 62. Although FIG. 1 shows that the pivoting base 61 is cylindrical, any suitable shape can be used. The pivoting base 61 can include an interior cavity 65 in which one or more annuluses 66 and 67 protrude into the interior cavity 65 and an aperture 64 runs through the center of the pivoting base 61 into the interior cavity 65. The inner wall 68 of the pivoting base 61 includes a protrusion 69 that extends into and runs along the longitudinal length of the interior cavity 65. The protrusion 69 is configured to engage a portion of the resilient member 70, which will be described later.

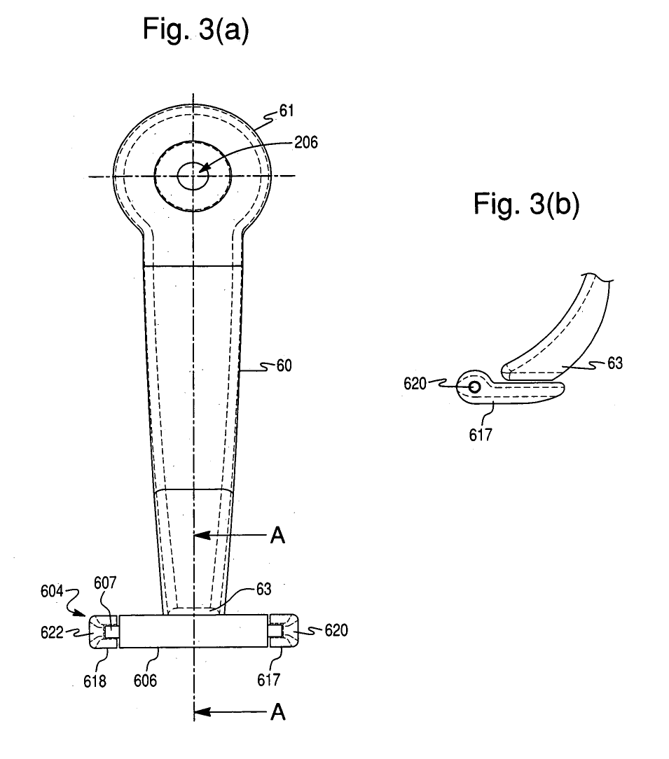

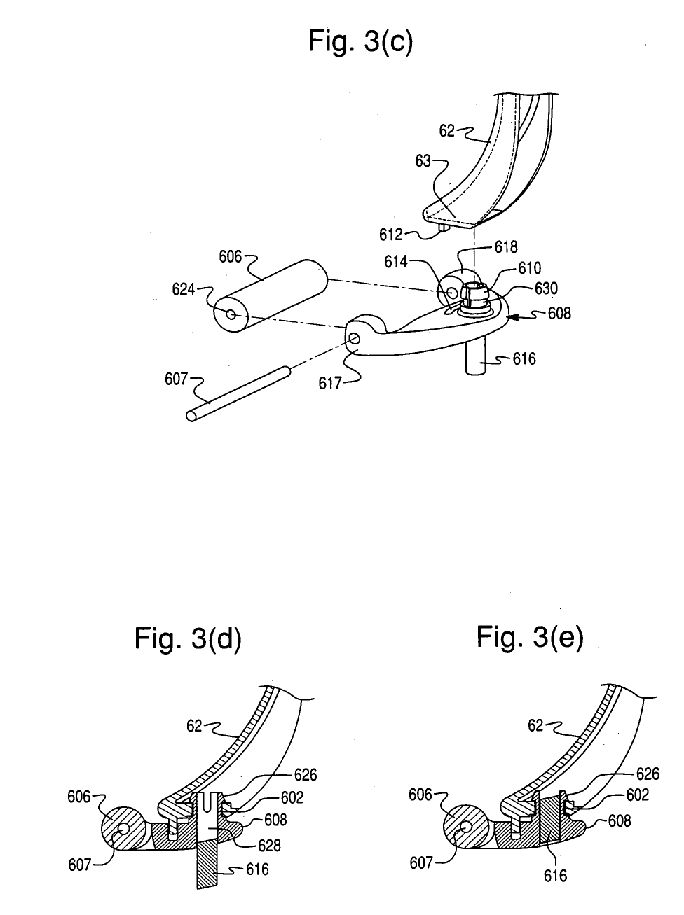

The distal portion 63 is a segment that can be attached or integrated with the shaft portion 62. The distal portion 63 runs approximately perpendicular to the shaft portion 62 and includes an aperture 602 (shown in FIG. 1), which is used for the attachment of a seat belt guide (not shown). The seat belt guide 63 may take many forms, for example, the D-ring type structure as shown in FIGS. 3(a)-3(e). FIG. 3(a) shows an example of a seat belt guide 604 in the form of a D-ring type structure attached to a presenting arm 60. FIG. 3(b) shows a side view of the seat belt guide 604 shown in FIG. 3(a). FIG. 3(c) shows and exploded view of the assembly of the seat belt guide 604 shown in FIG. 3(a). FIGS. 3(d) and 3(e) show cross sectional views taken along section line A-A of FIG. 3(a) before and after securing the seat belt guide 604 to the distal end 63 through a staking operation of the push pin 616.

As shown in FIG. 3(c), the seat belt guide 604 may comprise a roller 606, a guide pin 607, a guide body 608, and a push pin 616. The guide body 608 can comprise a right wall 617 and a left wall 618 in which the roller 606 is placed therebetween. The right wall 617 has an aperture 620 while the left wall 618 has another aperture 622. The apertures 620 and 622 are aligned so that the guide pin 607 can be pushed through an aperture at either the right or left wall through an aperture 624 in the roller 606 and inserted into the corresponding aperture in the other wall of the guide body 608. The guide pin 607 should be fully seated in the apertures of the guide body 608, as shown in FIG. 3(a), and any means to secure the pin inside the apertures 620 and 622 can be used. It is noted that the roller 606 should be able to freely rotate after the guide pin 607 is fully seated.

The guide body 608 may also include an attachment mechanism which is used to secure the guide body 608 to the distal end 63 of the presenting arm 60. One example of an attachment mechanism is the expandable insert 610 in FIGS. 3(c)-3(e). The expandable insert 610 extends from the top surface of the guide body 608 in which a cylindrical shaft forms a tapered tip 626. A hole 628 extends from the bottom surface of the guide body 608 through to the top of the tapered tip 626. The tapered tip 626 includes one or more slits which allow the tip to be compressed into hole 602 of the distal end 63, as shown in FIG. 3(d). To attach the guide body 608 to the distal end 63, the expandable insert 610 is inserted into the aperture 602 so that the edge 630 of the tapered tip 626 fully passes through the aperture 602, as seen in FIG. 3(d). Afterwards, a push pin 616 is inserted into the aperture 628 such that it expands the expandable insert 610 so that the edge 630 of the tapered tip 626 is enlarged to the point that the tip 626 cannot be removed from the aperture 602, as seen in FIG. 3(e). It should be noted that the push pin should be flush or below the surface of the guide body, as seen in FIG. 3(e). The push pin may be secured inside the aperture 628 by any known means, such as a adhesive seal used as a cover.

Optionally, the rotation of the guide body 608 about the distal end 63 of the presenting arm 60 can be limited through the use of a tab 612 on the distal end 63 of the presenting arm and a slot 614 on the guide body 608, as seen in FIGS. 3(c)-3(e). The tab 612 can be a small rectangular protrusion that is inserted into the slot 614 which can be an arc-shaped groove. The use of the tab 612 and slot 614 will allow the guide body to be limited to only a specified amount of rotation about its axis of rotation on the presenting arm 60, i.e., the center line of the push pin 616 and the aperture 602.

Referring back to FIG. 1, the presenter arm assembly 10 may also include a resilient member 70. In one embodiment, the resilient member 70 is an elastic metal material, which returns to its original shape after being deformed. For example, the resilient member 70 can be a spring. In the embodiment shown in FIG. 1, the resilient member 70 is a circular spring in which the inner diameter of the spring is larger than the outer diameter of the annulus 66 of the pivoting base 61. In this case, the spring may include one or more turns of wire to form a compressed coil. In the embodiment shown in FIG. 1, the resilient member 70 includes a first bent end 72 and a second bent end 74. The first bent end 72 can abut against the protrusion 69 of the pivoting base 61 of the presenting arm 60. By the same token, the bent end 74 can abut against the retaining arm 104 of the attachment bracket 100, which will described in detail below.

The base insert 80 may be a plastic piece which is inserted into the inner diameter of the annulus 66 of the presenting arm 60. The base insert 80 may be generally cylindrical with one open end. As seen in FIGS. 1 and 2 the base insert 80 may comprise a circumferential surface 84, a flat surface 86, an aperture 82 that extends through the flat surface, and two tabs 88 and 89 protruding from the flat surface 86. The base insert's circumferential surface 84 is approximately the same length as the longitudinal length of the annulus 66 protruding into the interior cavity 65 of the pivoting base 61. In addition, the longitudinal length of the annulus 67 protruding into the interior cavity 65 is approximately the same length as the base insert's circumferential length surface 84 minus the thickness of the flat surface 86. The base insert may optionally have a groove 81 that is used to seat the sealing member 90. The sealing member 90 can be any pliant or elastic material, such as an O-ring. Alternatively, the sealing member and the groove can be removed from the assembly.

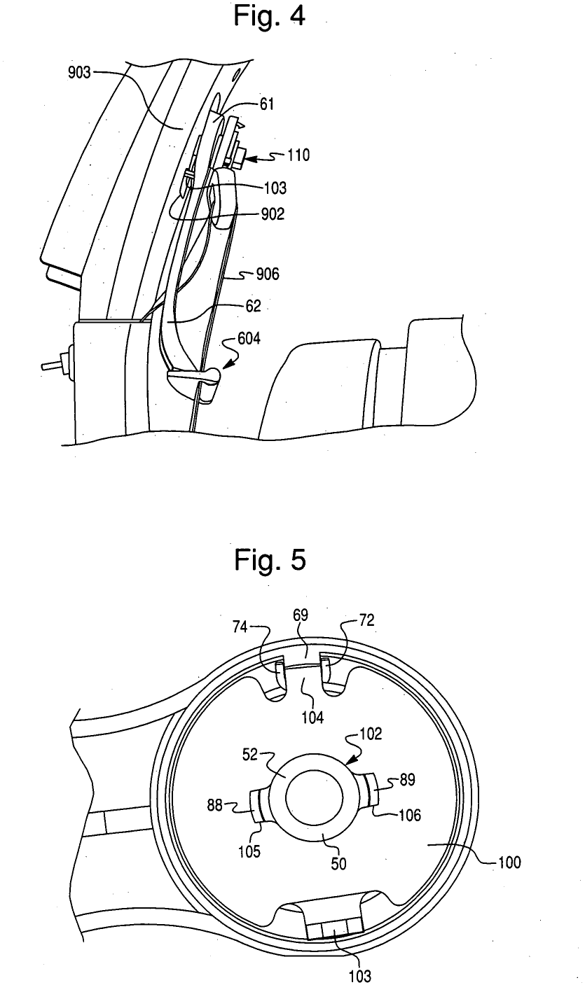

The attachment bracket 100 may be a metal piece which includes a flat plate 101, an aperture 102, an anchoring arm 103, and a retaining arm 104. The anchoring arm 103 fits inside a slot in the vehicle body such that the attachment bracket 100 will not rotate relative to the vehicle body. FIG. 4 shows the presenter arm assembly attached to a vehicle interior and rotated downward from its home position. As seen in FIG. 4, the anchor arm 103 of the attachment bracket is inserted into the mating slot 902 in the vehicle pillar 903 to prevent the attachment bracket from rotating. Thus, once the attachment bracket 100 is mounted on the vehicle with the bolt 110 along with the rest of the presenter arm assembly, it is not configured to move relative to the vehicle body. Referring back to FIG. 1, the aperture 102 of the attachment bracket 100 includes two ear portions 105 and 106, which is used to accommodate the two tabs 88 and 89 of the base insert 80. The two tabs 88 and 89 fit inside the ear portions 105 and 106 such that the base insert 80 will not rotate relative to the vehicle body by virtue of its connection to the attachment bracket 100.

The discussion will now focus on FIG. 2 in which a subassembly 200 is shown to comprise the bushing 50, the pivoting base 61 of the presenting arm 60, the resilient member 70, the base insert 80, the sealing member 90, the attachment bracket 100, and a single D-ring piece 202. As can be seen in this figure, the bushing 50 can be inserted into the hole 204 of the single D-ring piece 202, the hole 64 of the pivoting base 61 of the presenting arm, the aperture 82 of the base insert 80, and the aperture 102 of the attachment bracket 100 such that the bushing, pivoting base, the base insert, the sealing member, and the attachment bracket are aligned with each other. With the bushing in place, the bolt 110 in FIG. 1 can be inserted through the aperture 51 of the bushing and be screwed into a threaded fixture attached to or part of an interior structure of the vehicle. The bushing can be a bearing which can help facilitate the rotation of the presenting arm relative to the vehicle structure along the rotational axis which runs along the center line 206. In addition, the bushing also acts as a spacer due to the various diameters abutting against various other components along its longitudinal direction. Thus, when the bolt 11 is screwed into the threaded fitting, the possibility of the other components being damaged due to over-tightening is diminished.

FIG. 2 shows how the pivoting base interacts with the other parts of the subassembly 200. The base insert 80 may inserted into the annulus 66 such that there is a small gap 208 between the internal surface 603 of the annulus 66 and the outer circumferential surface 84 of the base insert 80. At the same time, the sealing member 90 is held in the groove 81 by the compression force of the flat plate 101 of the attachment bracket 100, which is caused by the bolt 110 being screwed into the threaded fitting for attachment to the vehicle.

The small gap 208 is annular in shape and is located between the internal surface 603 of the annulus 66 and the outer circumferential surface 84 of the base insert 80. In the small gap 208, a viscous damper, such as silicone grease or other like material, may be located. The purpose of the damper is to regulate the rotation of the presenting arm to a slow, gentle rotation; thus, preventing the presenting arm from snapping into back into its home, or presenting, position after being rotated by a vehicle occupant person. The sealing member 90 may be used to retain the viscous damper inside the small gap 208.

The resilient member 70 encircles the outer surface of the annulus 66. The bent ends 72 and 74 of the resilient member 70 are placed such that the restraining arm 104 of the attachment bracket 100 and the protrusion 69 of the pivoting base 61 fit between both bent ends, as seen in FIG. 5.

FIG. 5 shows the subassembly from the view of the attachment bracket 100 in which a portion 52 of the bushing 50 protrudes out from the aperture 102 of attachment bracket 100. In addition, the tabs 88 and 89 of the base insert 80 are protruding into or through the eared portions 105 and 106 of the aperture 102 of the attachment bracket 100. These tabs prevent the base insert 80 from rotating relative to the attachment bracket 100. Also, as shown in FIG. 5, the restraining arm 104 of the attachment bracket 100 is located to the right of the bent end 74 of the resilient member 70 and to the left of the bent end 72. As assembled, the resilient member 70, the base insert 80, and the sealing member 80 are all housed within the pivoting base 61 of the presenting arm 60 with the flat plate 101 of the attachment acting like a cover for the components located within.

The presenting arm 60 and D-ring single piece 202 (or the D-ring guide 30 and D-ring guide plate 40 combination) are configured to rotate about the center of axis 206, as seen in FIG. 2. The presenting arm 60, however, is held in place due to the bent ends 72 and 74 of the resilient member 70 as seen in FIG. 5. The bent ends 72 and 74 extend beyond the restraining arm 104 of the attachment bracket 100 and abut against the protrusion 69 of the pivoting base 61. In this position, the bent ends 72 and 74 are biased to exert a force toward each other such that the protrusion 69 and the restraining arm 104 are kept in close proximity to each other.

As shown in FIG. 5, the presenter arm assembly is biased to extend at a predetermined angle from the interior structure of the vehicle such that the seat belt may be presented in a front seat passenger. FIG. 6 shows an orientation of the presenting arm assembly when the protrusion 69 of the presenting arm 60, the resilient member 70, and the attachment bracket 100 are in the configuration as shown in FIG. 5. The configuration of the presenting arm in FIGS. 5 and 6 is known as the home, or presenting, position, i.e., the natural position of the presenting arm when no external force is applied by the vehicle occupant to the presenter arm assembly. It should be noted that the predetermined angle can be any angle suitable for presenting the seat belt to the occupant of the seat. The predetermined angle can be set to a desired angle, by simply setting, for example, the spacing between the bent ends 72 and 74 to a desired minimum distance. The minimum distance may be determined by the width of the protrusion 69. Alternatively, the minimum distance may be greater than the width of the protrusion 69 if the distance between the bent ends 72 and 74 in the resilient member's natural state is greater than the width of the protrusion 69.

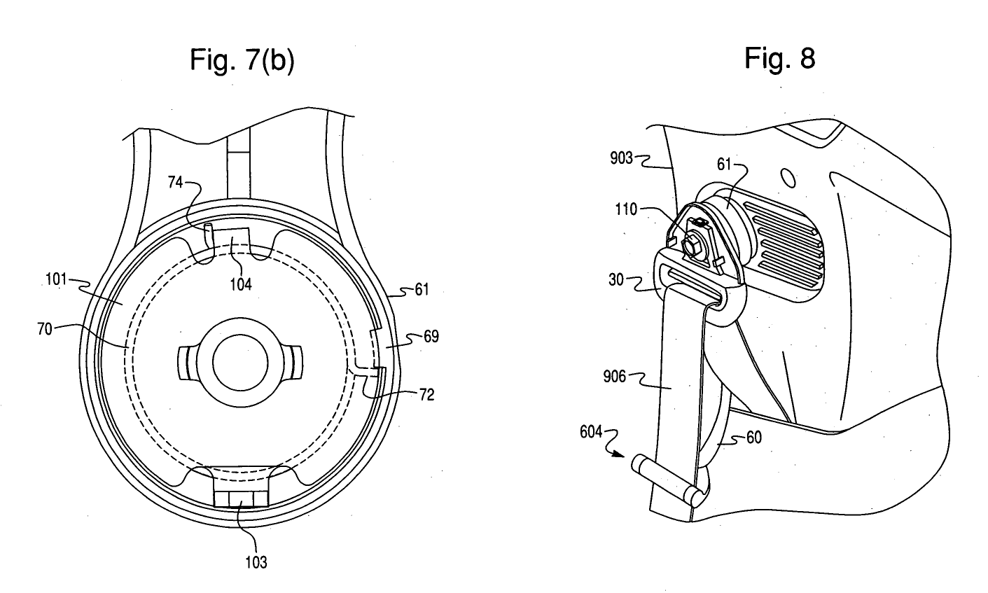

Now the operation of the presenter arm assembly will be discussed. If it is desired to rotate the presenting arm so that a vehicle occupant, for example, wishes to gain access to the rear seat of the vehicle, the occupant merely pushes downward at or near the distal end 63 of the presenting arm 60. As the force is applied to the distal end 63, the presenting arm 60 and D-ring single piece 202 (or the D-ring guide 30 and D-ring guide plate 40 combination) are rotated downward about the center of rotation (i.e., at bolt 110) as the force of the occupant overcomes the biasing force of the spring which brings the bent ends toward each other and keeps the presenting arm 60 in place. The rotation of the presenting arm 60 causes the protrusion 69 of the pivoting base 61 to apply a force to the bent end 74, which is greater than the biasing force of both bent ends. This applied force causes the bent ends 72 and 74 to separate since the protrusion pushes the bent end 74 counter clockwise while the restraining arm 104 of the attachment bracket 100 maintains the placement of the bent end 72, as seen in FIG. 7(a). FIG. 8 shows an orientation of the presenting arm when the protrusion 69 of the presenting arm 60, the resilient member 70, and the attachment bracket are in the configuration as shown in FIG. 7(a). The configuration of the presenter arm assembly shown in FIGS. 7(a) and 7(b) is known as a “rotated position.”

As long as the force applied to the distal end 63 is stronger than the biasing force of the spring to bring the bent ends toward each other, the presenting arm can be rotated to any angle that is suitable to the occupant causing the rotation. Once the occupant no longer needs to have the presenting arm rotated out of its home position, the occupant simply needs to let go of the presenter arm assembly. As a result, the biasing force of the spring 70 moves the bent end 74 toward the bent end 72. Thus, the bent end 74 in FIG. 7(a) pushes the protrusion 69 of the presenting arm 60 in the clockwise direction until the protrusion is in the proximity of the bent end 72 and the restraining arm 104 as seen in FIG. 5. Thus, the presenter arm assembly returns to its home position as seen in FIG. 6.

As the presenting arm rotates in the clockwise direction (when the bent end 74 rotates toward the bent end 72) after the vehicle occupant releases the presenter arm assembly, the viscous damper in the gap 208 slows the rotation of the presenting arm such that the presenting arm is prevented from immediately snapping back into position and possibly injuring or damage any person or object that may be in the way of the presenter as it rotates about the axis of rotation 206. The viscous damper can be silicone grease, an O-ring in a groove, or the like.

In addition to the presenting arm being rotated in counter-clockwise direction (from its home position in FIG. 6 to a rotated position in FIG. 8), the presenting arm can also be rotated in a clockwise direction. For example, the occupant can merely push upward at or near the distal end 63 of the presenting arm 60. As the force is applied to the distal end 63, the presenting arm 60 and D-ring single piece 202 are rotated upward about the center of rotation at bolt 110 as the force of the occupant overcomes the biasing force of the spring that brings the bent ends toward each other and keeps the presenting arm 60 in place. The rotation of the presenting arm 60 causes the protrusion 69 of the pivoting base 61 to apply a force to the bent end 72, which is greater than the force biasing both bent ends toward each other. This applied force causes the bent ends 72 and 74 to separate since the protrusion pushes the bent end 72 clockwise while the restraining arm 104 of the attachment bracket maintains the placement of the bent end 74, as seen in FIG. 7(b). The configuration of the presenter arm assembly shown in FIG. 7(b) is another “rotated position.”

As long as the force applied to the distal end 63 is stronger than the biasing force of the spring that brings the bent ends toward each other, the presenting arm can be rotated to any angle that is suitable to the occupant causing the rotation. Once the occupant no longer needs to have the presenting arm rotated out of its home position, the occupant simply needs to let go of the presenter arm assembly. As a result, the biasing force moves the bent end 72 toward the stationary bent end 74. Thus, the bent end 72 in FIG. 7(b) pushes the protrusion 69 of the presenting arm 60 in the counter-clockwise direction until the protrusion is in the proximity of the bent end 74 and the restraining arm 104 as seen in FIG. 5. Thus, the presenter arm assembly returns to its home position again as seen in FIG. 6.

As the presenting arm rotates in the counterclockwise direction (when the bent end 72 rotates toward the bent end 74), the viscous damper in the gap 208 slows the rotation of the presenting arm such that the presenting arm is prevented from immediately snapping back into position. Thus, possible injury or damage to any person or object that may be in the way of the presenting arm may be avoided.

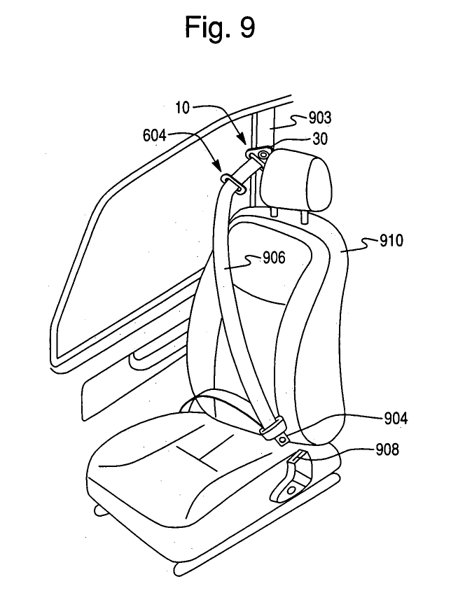

FIG. 9 shows the presenter arm assembly as it is used in a vehicle, such as a automobile, truck, airplane, or any other passenger vehicle. The presenter arm assembly 10 can be attached to a pillar 903 of a vehicle. A seat belt 906 feds through the arm presenter assembly 10 at the D-ring guide 30 and the seat belt guide 604 such that the belt 906 can be easily reached by the vehicle occupant that sits in the seat 910. A tongue assembly 904 feds through the seat belt 906 and is capable of being connected to a buckle 908, which can be attached to the seat 910, the vehicle floor, or the like. The presenter arm assembly is configured to remain at a predetermined angle from the pillar 903 due to the selection of the minimum distance possible between the bent ends 72 and 74 of the resilient member 70.

A presenter arm assembly for presenting a seat belt to a vehicle occupant has been disclosed which has a simple design and can automatically return to the presenting position after being rotated to allow entry into the rear seat of a vehicle. Because the presenter arm assembly rotates back to its home position, there is a reduction in the risk of adding slack to the belt. Slack can be caused when a vehicle occupant puts on a seat belt when the presenter arm assembly is rotated out of position, and thus is further away from the seat belt buckle than when its in its home position. If this is the case, when the vehicle occupant puts on the seat belt, more length of the seat belt is withdrawn than necessary. When the presenter arm assembly is placed back into position, the assembly moves closer to the seat belt buckle and the excess seat belt length either needs to be withdrawn or, if not withdrawn, produces slack about the vehicle occupant. Such slack can be avoided through the use of the presenter arm assembly of the present disclosure.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention, The scope of the present invention is to be defined as set forth in the following claims.

What is claimed is:

1. A presenter arm assembly for presenting a seat belt to a vehicle occupant comprising:
a presenting arm with a pivoting base having an interior cavity and a shaft portion extending from the pivoting base;
a seat belt guide attached to an end of the shaft portion for guiding a seat belt;
an attachment bracket with a fixed portion that is adapted to engage a structure of a vehicle; and
a resilient member that engages the presenting arm and the attachment plate such that the presenting arm is biased to extend at a predetermined angle relative to the fixed portion of the attachment bracket.

2. The presenter arm assembly according to claim 1, wherein the attachment bracket comprises an engaging arm that extends into the interior cavity of the pivoting base of the presenting arm, and
wherein the resilient member engages the engaging arm of the attachment plate.

3. The presenter arm assembly according to claim 1, wherein the pivoting base comprises an engaging protrusion that extends into the interior cavity, and
wherein the resilient member engages that engaging protrusion of the pivoting base.

4. The presenter arm assembly according to claim 1, wherein the resilient member is a spring.

5. The presenter arm assembly according to claim 1, further comprising a viscous damper in operative communication with the presenting arm and the attachment bracket.

6. The presenter arm assembly according to claim 5, wherein the viscous damper is silicone grease.

7. The presenter arm assembly according to claim 5, further comprising a sealing ring for retaining the viscous damper in the presenting arm.

8. The presenter arm assembly according to claim 1, further comprising a bushing inserted into an aperture of the pivoting base of the presenting arm to act as a pivot for the presenting arm.

9. The presenter arm assembly according to claim 1, wherein the seat belt guide comprises a roller and a guide body attached to the shaft portion of the presenting arm, wherein a seat belt is capable of sliding between the roller and the guide body.

10. A presenter arm assembly for presenting a seat belt to a vehicle occupant comprising:
a presenting arm with a pivoting base having an interior cavity and a shaft portion extending from the pivoting base;
a seat belt guide attached to an end of the shaft portion for guiding a seat belt;
a base insert disposed inside the interior cavity, and
a viscous damper provided inside the presenting arm.

11. The presenter arm assembly according to claim 10, wherein the viscous damper is silicone grease.

12. The presenter arm assembly according to claim 10, further comprising a sealing ring for retaining the viscous damper inside the presenting arm.

13. The presenter arm assembly according to claim 10, further comprising:
an attachment bracket with a fixed portion that is adapted to engage a structure of a vehicle;
a spring that engages the presenting arm and the attachment bracket such that the presenting arm is biased to extend at a predetermined angle from the fixed portion of the attachment bracket.

14. The presenter arm assembly according to claim 10, further comprising a bushing inserted into an aperture of the pivoting base to act as a pivot for the presenting arm.

15. The presenter arm assembly according to claim 10, wherein the seat belt guide comprises a roller and a guide body attached to the shaft portion of the presenting arm, wherein a seat belt is capable of sliding between the roller and the guide body.

16. A seat belt assembly for restraining an occupant in a vehicle comprising:
a presenter arm assembly comprising:
a presenting arm with a pivoting base having an interior cavity and a shaft portion extending from the pivoting base;
a seat belt guide attached to an end of the shaft portion for guiding a seat belt;
an attachment bracket including a fixed portion that is adapted to engage an interior structure of a vehicle; and
a resilient member that engages the presenting arm and the attachment plate such that the presenting arm is biased to extend at a predetermined angle from the fixed portion of the attachment bracket;
a buckle; and
a seat belt having a tongue attached for insertion into the buckle, wherein the seat belt slides along the seat belt guide.

17. The seat belt assembly according to claim 16, further comprising a viscous damper in operative communication with the presenting arm and the attachment bracket.

18. The seat belt arm assembly according to claim 16, wherein the viscous damper is silicone grease.
